(19) United States
(12) Patent Application Publication
(10) Pub. No.: US 2019/0362282 A1
(43) Pub. Date: Nov. 28, 2019

(54) OPERATIONAL RECOMMENDATIONS BASED ON MULTI-JURISDICTIONAL INPUTS

(71) Applicant: Conduent Business Services, LLC, Dallas, TX (US)

(72) Inventors: Sharanya ESWARAN, Bangalore (IN); Sakshi AGARWAL, Kolkata (IN); Sitara SHAH, Mumbai (IN); Krishnaprasad NARAYANAN, Chennai (IN); Shisagnee BANERJEE, Kolkata (IN); Terry JOHNSTON, Palm Bay, FL (US); Avantika GUPTA, U. P. (IN); Tridib MUKHERJEE, Bangalore (IN)

(73) Assignee: Conduent Business Services, LLC, Dallas, TX (US)

(21) Appl. No.: 15/988,247

(22) Filed: May 24, 2018

(51) Int. Cl. G06Q 10/06; G06F 17/30; G06N 7/00; G06Q 10/04; G06Q 50/26

(52) U.S. Cl. CPC G06Q 10/06311; G06F 17/30241; G06Q 50/26; G06Q 10/04; G06N 7/005

(57) ABSTRACT

Crime information that corresponds to a set of crimes occurrences is gathered. This information is processed time series datasets associated with geographical regions. Based on the time series datasets, a target geographical region is grouped (clustered) with a set of other geographical regions. This clustering is based on statistical similarities among respective time series datasets. Operational information associated with the geographical regions is received. Based on the operational information, and the clustering, a recommended operational allocation is selected to be used in the target geographical region.

### FIELD

Embodiments relate generally to crime analytics and crime forecasting.

### TECHNICAL BACKGROUND

Crime analysis is a law enforcement function that involves identifying patterns and trends in crime and disorder. Operational decisions such as staffing, shift assignment, and/or deployment of resources can be made based on crime patterns. However, if such crime patterning is inaccurate, these operational decisions will be ineffective and/or wasteful of resources.

### OVERVIEW

In an embodiment, a method of operating a crime forecasting system includes receiving, from a plurality of source databases, crime information that corresponds to a plurality of crimes occurrences. The information includes respective locations for the plurality of crime occurrences, respective times for the plurality of crime occurrences, and respective types of crime for the plurality of crime occurrences. The crime information is processed into a plurality of time series datasets associated with substantially non-overlapping geographical regions. The time series datasets relate time information to crime occurrences in respective substantially non-overlapping geographical regions. Based on the plurality of time series datasets, clustering information is generated that groups a target geographical region with a first set of the substantially non-overlapping geographical regions. The clustering information is based on statistical similarities among respective time series datasets associated with the target geographical regions and each of the first set of substantially non-overlapping geographical regions. Operational information associated with at least one of the first set of substantially non-overlapping geographical regions is received. Based on the operational information associated with at least one of the first set of substantially non-overlapping geographical regions, and the clustering information, a recommended operational allocation is selected to be used in the target geographical region.

In an embodiment, a method of operating a crime forecasting system includes receiving, from a plurality of source databases, crime information that corresponds to a plurality of crimes occurrences. The information includes respective locations for the plurality of crime occurrences, respective times for the plurality of crime occurrences, and respective types of crime for the plurality of crime occurrences. The crime information is processed into a plurality of time series datasets associated with a set of geographical regions. The time series datasets relate time information to crime occurrences in respective geographical regions. Based on the plurality of times series datasets, a set of statistical feature sets associated with crime patterns in respective members of the set of geographical regions are calculated. Based on the statistical feature sets, a subset of geographical regions are associated with a cluster of geographical regions. A set of operational decisions associated with each of the respective members of the cluster of geographical regions is received. The set of operational decisions ware correlated with the crime patterns in each of the respective members of the cluster of geographical regions. Based on the correlations between the set of operational decisions and the crime patterns, an operational recommendation for at least one of the geographical regions is generated.

### BRIEF DESCRIPTION OF THE DRAWINGS

FIG. 1 is a block diagram illustrating an operational recommendation system.

FIG. 2 is a flowchart illustrating a method of operating an operational recommendation system.

FIG. 3 is flowchart illustrating a method of making operational recommendations.

FIG. 4 is a flowchart illustrating a method to use cluster data for operational recommendations.

FIG. 5 is a diagram illustrating operational recommendations based on multi-jurisdictional inputs.

FIG. 6 illustrates a processing node.

### DETAILED DESCRIPTION

In an embodiment, crime data is gathered from multiple law enforcement agencies (LEAs). This data is formatted and then analyzed to extract one or more crime patterns. For example, for a given jurisdiction (i.e., geographical area), there may be an intermittent, but extractable, pattern whereby drunk driving stops sometimes increase on the second Wednesday of the month. A similar extracted pattern may also appear in other jurisdictions. For example, another jurisdiction that appears unrelated (e.g., far distant, different population, different economy, different affluence, etc.) to the given jurisdiction may also exhibit an intermittent increase in drunk driving stops on the first Wednesday of the month.

Operational data (beat schedules, shift schedules, location schedule, deployment schedule, etc.) from the law enforcement agencies in a cluster is also gathered. The crime patterns from the jurisdictions in a cluster are correlated with the operational data from those jurisdictions. This allows the operational decisions of a given jurisdiction to be compared and ranked against the operational decisions in the other jurisdictions. Based on these comparisons, operational recommendations are made to improve key performance indicators.

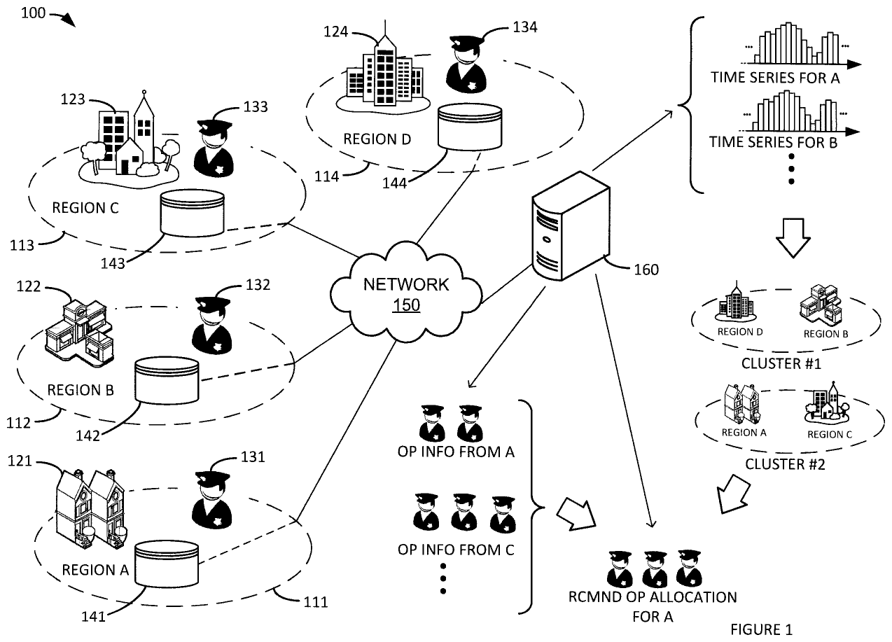

FIG. 1 is a block diagram illustrating an operational recommendation system. In FIG. 1, a multi-jurisdictional system 100 that includes geographical regions 111-114 are illustrated. Geographical regions 111-114 may be substantially non-overlapping. Geographical regions may correspond to, for example, one or more of the coverage area of a law enforcement agency (LEA), a county, a city, township, city block, and/or an arbitrarily selected area (e.g., a grid unit).

Each geographical region 111-114 is associated with respective attributes 121-124. These attributes may include or correspond to, for example, indicators of population, population density, economic status (e.g., percentage of population below poverty line, income percentile distribution, etc.), educational status (e.g., percentage of high school graduates, percentage of college graduates, percentage of post-graduates, etc.), and/or functional characteristic(s) (e.g., university town, port town, state capital, rust belt town, diversified economy town, retirement town, industrial city, suburban town, rural area, etc.)

Each geographical region 111-114 is policed by one or more law enforcement agencies 131-134. These law enforcement agencies 131-134 create, track, and maintain information about crimes that occur within their respective geographical regions 111-114. This information may include, but is not limited to, the locations of crime occurrences, times the of crime occurrences, and the type(s) of crime that was committed. This information may be stored in databases 141-144. These databases 141-144 may utilize different methods of access, different categorization of crimes, etc.

Recommendation system 160 may aggregate data from the different source databases 141-144. The data aggregation process may include, but is not limited to: (i) reconciling the dates of in databases 141-144 (ii) reconciling the latitudes and longitudes in databases 141-144 (because databased 141-144 may use different coordinate systems); and, (iii) use regular expression and keyword based processes to categorize incidents into specific crime categories. In an embodiment, the crime categories and the corresponding keywords and regular expressions may be configurable by a user of recommendation system 160.

Recommendation system 160 may periodically pull data from the source databases 141-144 at selected times. When data is pulled, recommendation system 160 updates internal to recommendation system 160 databases with the updated data. Depending on when source databases 141-144 are updated, recommendation system 160 may poll respective databases 141-144 at different frequencies.

Recommendation system 160 processes the crime information from databases 141-144 into time series datasets. Each of these time series datasets is associated with a geographical region 111-114. The time series datasets relate time information to crime occurrences/incidents in respective the geographical regions. The time series datasets may be processed into series that have different time scales (e.g., monthly, weekly, daily, etc.). In an embodiment, the time scales may be configurable by the user.

Based on the plurality of time series datasets, recommendation system 160 generates clustering information that creates groups of geographical regions 111-114. This clustering information is based on statistical similarities among the time series datasets associated with the geographical regions 111-114 that are clustered (grouped) together. The clustering may be based on statistical features in the times series datasets such as trend, seasonality, serial correlation, non-linearity, skewness, kurtosis, self-similarity, chaos, frequency of periodicity, average Maharaj Distance, moving average factor, and number of direction changes. Other statistical features may be used as part of the clustering process.

In an embodiment, recommendation system 160 uses the Average Maharaj distance for statistical feature extraction. An Autoregressive Moving Average (ARMA) time series with autoregression parameter p and moving average parameter q can be defined according to equation (1) as follows:

$${Y}_{T} = λ + {\sum }_{i = 1}^{p} {ψ}_{i} {Y}_{T - i} + {\sum }_{i = 1}^{q} {θ}_{i} {ϵ}_{T - i} + {ϵ}_{T} \qquad ( 1 )$$

In Equation (1), λ is a constant, ∈ᵢ's is are white noise, ψᵢ's are the autoregression parameters and θᵢ's are the moving average parameters. For such ARMA processes, discrepancy measures based on hypotheses testing can be used to determine whether or not two time series datasets X_{T} and Y_{T} have significantly different (or significantly the same) generating processes. The output metric of the ARMA process is called the Maharaj distance. The Maharaj distance may be used by recommendation system 160 to determine whether one or more time series dataset are similar to each other. A p-value is computed from the Maharaj distance which lies between 0 and 1. A p-value close to 1 indicates that a selected two time series datasets are similar. A p-value close to 0 indicates that a selected two time series datasets are different. For purposes of feature extraction, the average Maharaj distance (AMD) for the time series related to the i-th region can computed as according to Equation (2) as follows:

Σ_{j≠i}^{N}MDᵢⱼ/(N−1) (2)

In Equation 2, MDᵢⱼ is the Maharaj distance of the time series from geographical region i from the time series from geographical region j, and N is the total number of geographical regions. Thus, equation (2) gives the average dissimilarity of a given geographical region from the other geographical regions.

The number q as defined in Equation 1 is thus a moving average factor. In addition, the number of direction change can be determined. For a certain geographical region 111-114, an increase or decrease in crime is an important indicator of the overall crime pattern of that geographical region 111-114. If the number of crimes increases frequently from a previous time interval, then that can be a differentiating factor as compared to those regions where crime patterns remain static. The number of changes in direction in the time series datasets may therefore be determined by recommendation system 160. Specifically, for a geographical region's data Y_{T}, a function δT such that δ1=δ2+0. Accordingly, equation (3) expresses:

$${δ}_{T} = \{ \begin{matrix}0 & if {Y}_{T} \geq {Y}_{T - 1} \geq {Y}_{T - 2} or {Y}_{T} \leq {Y}_{T - 1} \leq {Y}_{T - 2} \\ 1 & otherwise\end{matrix} \qquad ( 3 )$$

Let Δ=TδT. Then Δ is the sum of the number of direction changes and is taken to be a statistical feature.

Based on the calculated statistical feature sets, recommendation system 160 may then associate the respective geographical regions 111-114 with one of a set of clusters. In order to cluster the geographical regions 111-114, recommendation system 160 may, for each statistical feature set, identify feature distributions. Recommendation system 160 may use a mixture model-based to cluster the geographical regions.

Recommendation system 160 may use candidate list of mixture distributions C that includes a Gaussian mixture, a t mixture, a chi-square mixture, a Poisson mixture, and an inverse Gaussian mixture. For this discussion, Mₖ is the kth member of C. Y_{Ti} is the set of extracted features. Mₖ can then be fit to Y_{Ti} and an estimation of the parameters using an Expectation Maximization (EM) algorithm is performed by recommendation system 160. The fitted likelihood is denoted L. The Bayesian Information Criteria (BIC) is used to extract information from the fitted model. BIC for a fitted model with likelihood L is defined in equation (4) as:

BIC=2 log [symbol] (\hat{ϑ}|x)−ρ log n (4)

where x is the dataset, \hat{ϑ} is the maximum likelihood estimate (MLE) of the parameter set ϑ, is the number of free parameters, and n is the number of observations. BICₖ is the information theoretic criteria corresponding to the kth member of C. Equation (5) can then be defined as follows:

$${k}_{0} = arg {max}_{k} {BIC}_{k} \qquad ( 5 )$$

Mₖ_{₀} is the best fitted mixture model for the dataset. Thus, in an embodiment, recommendation system 160 choses the mixture distribution (e.g., Gaussian, Poisson, etc.) that gives the highest information based on the time series data and uses these selections to cluster the geographical regions 111-114. In other words, all the geographical regions with the same (or statistically similar) mixture distributions are associated with the same cluster.

Recommendation system 160 also gathers operational information from the geographical regions. Based on the operational information from geographic regions 11-114 within a cluster, recommendation system 160 may make operational recommendations. These recommendations may be based on, for example, correlations between crime patterns in the regions 111-114 of a cluster and the operational decisions made by the regions 111-114. Thus, it should be understood instead of basing operational recommendations on operational data from regions 11-114 that have different crime patterns, recommendation system 160 bases its operational recommendations on operational data from regions 111-114 with similar crime patterns (i.e., those regions that are in the same cluster—which clustering is based on the similarity of crime patterns.)

In an embodiment, after clustering, recommendation system 160 may augment one or more time series datasets for a geographical region 111-114 with the time series dataset(s) from one or more geographical regions 111-114 that are in the same cluster. For example, to improve the accuracy of a crime pattern associated with geographical region 111, recommendation system 160 may augment (e.g., sum, interleave, concatenate, resample, or otherwise combine) the time series dataset for geographical region 111 (which, e.g., has been placed in a cluster) with the time series dataset that is from geographical region 112 (which, e.g., is also in the same cluster).

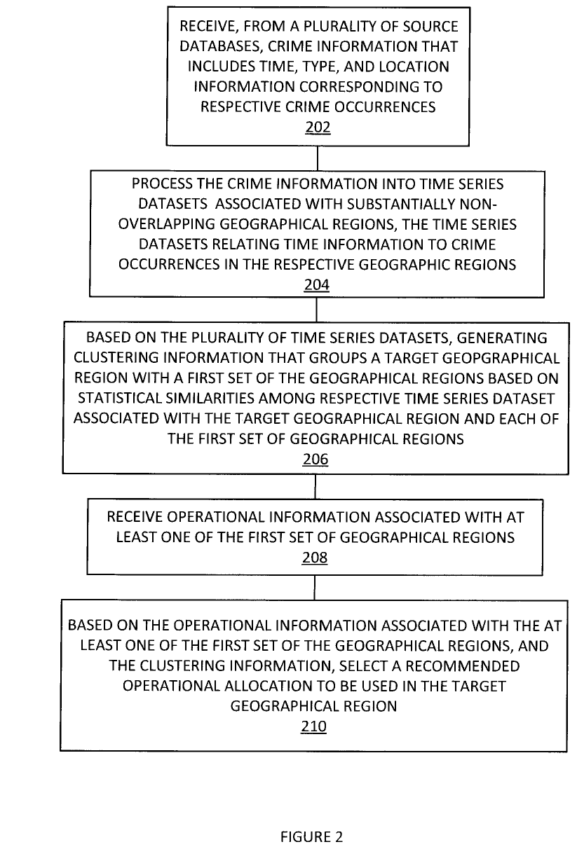

FIG. 2 is a flowchart illustrating a method of operating an operational recommendation system. The steps illustrated in FIG. 2 may be performed by one or more elements of multi-jurisdictional system 100. From a plurality of source databases, crime information that includes time, type, and location information corresponding to respective time occurrences is received (202). For example, recommendation system 160 may gather and aggregate data from the different source databases 141-144.

The crime information is processed into time series datasets associated with substantially non-overlapping geographical regions where the time series datasets relate time information to crime occurrences in the respective geographic regions (204). For example, recommendation system 160 may aggregate data from the different source databases 141-144. The data aggregation process may include, but is not limited to: (i) reconciling the dates in databases 141-144 (ii) reconciling the latitudes and longitudes in databases 141-144 (because databased 141-144 may use different coordinate systems); and, (iii) use regular expression and keyword based processes to categorize incidents into specific crime categories.

Based on the plurality of times series datasets, clustering information is generated that groups a target geographical region with a first set of the geographical regions based on statistical similarities among respective time series datasets associated with the target geographical regions and each of the first set of geographical regions (206). For example, recommendation system 160 may generate clustering information that creates groups of geographical regions 111-114. This clustering information is based on statistical similarities among the time series datasets associated with the geographical regions 111-114 that are clustered (grouped) together. The clustering may be based on statistical features in the times series datasets such as trend, seasonality, serial correlation, non-linearity, skewness, kurtosis, self-similarity, chaos, frequency of periodicity, average Maharaj Distance, moving average factor, and number of direction changes. Other statistical features may be used as part of the clustering process.

Operational information associated with at least one of the first set of geographical regions is received (208). For example, recommendation system 160 may gather and/or be provided operational information from the geographical regions 111-114 that are in the same cluster as the target region 111-114.

Based on the operational information associated with the at least one of the first set of the geographical regions, and the clustering information, a recommended operational allocation to be used in the target geographical region is selected (210). For example, recommendation system 160 may correlate the operational information from the regions in a cluster with key performance indicators of each region. An operational allocation that is well correlated with an improvement in a key performance indicator may be selected by recommendation system 160.

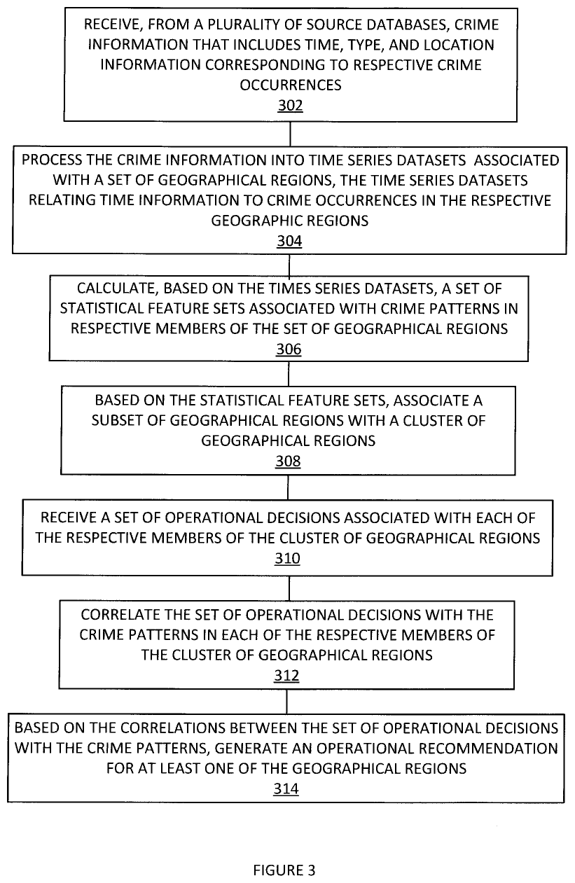

FIG. 3 is flowchart illustrating a method of making operational recommendations. From a plurality of source databases, crime information that includes time, type, and location information corresponding to respective crime occurrences is received (302). For example, recommendation system 160 may gather and aggregate data from the different source databases 141-144.

The crime information is processed into time series dataset associated with a set of geographical regions where the time series dataset relate time information to crime occurrences in the respective geographic regions (304). For example, recommendation system 160 may aggregate data from the different source databases 141-144. The data aggregation process may include, but is not limited to: (i) reconciling the dates of in databases 141-144 (ii) reconciling the latitudes and longitudes in databases 141-144 (because databased 141-144 may use different coordinate systems); and, (iii) use regular expression and keyword based processes to categorize incidents into specific crime categories.

Based on the time series datasets, a set of statistical feature sets associated with crime patterns in respective members of the set of geographical regions are calculated (306). For example, recommendation system 160 may determine, from the calculated time series datasets, statistical features that include one or more of trend, seasonality, serial correlation, non-linearity, skewness, kurtosis, self-similarity, chaos, frequency of periodicity, average Maharaj Distance, moving average factor, and number of direction changes.

Based on the statistical feature sets, a subset of geographical regions is associated with a cluster of geographical regions (308). For example, geographical regions 111-114 with the same (or statistically similar) statistical features (e.g., mixture distributions) may be associated by forecasting system 160 with the same cluster.

A set of operational decision associated with each of the respective members of the cluster of geographical regions is received (310). For example, recommendation system 160 may gather and/or be provided operational information from the geographical regions 111-114 that are in the same cluster as the target region 111-114.

The set of operational decisions is correlated with the crime patterns in each of the respective members of the cluster of geographical regions (312). For example, recommendation system 160 may correlate the operational information from the regions in the cluster with the crime patterns from the geographical regions. Thus, patterns such as lowering the staffing of a selected shift resulting in a higher rate of crime may be recognized. Based on the correlations between the set of operational decisions with the crime patterns, generate an operational recommendation for at least on of the geographical regions (314). For example, recommendation system 160 may, based on the correlations (or lack thereof) between the operational decisions and the crime patterns make an operational recommendation for a geographical region 111-114. Thus, a correlation between lowered shift staffing resulting in a higher rate of crime may result in a recommendation to increase the staffing of a selected shift. Likewise, a lack of a correlation between lowered shift staffing and a higher rate of crime may result in a recommendation that increasing the staffing of the selected shift will waste resources.

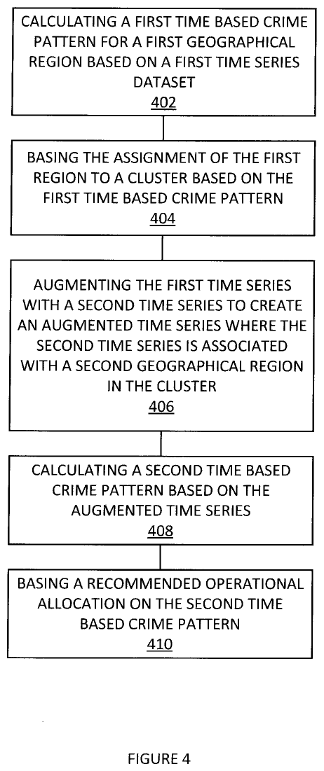

FIG. 4 is a flowchart illustrating a method to use cluster data for operational recommendations. A first time based crime pattern for a first geographical region is calculated based on a first time series dataset (402). For example, recommendation system 160 may process crime information from databases 141 into a time series dataset for region 111. This time series may be analyzed for crime pattern features such as trend, seasonality, serial correlation, non-linearity, skewness, kurtosis, self-similarity, chaos, frequency of periodicity, average Maharaj Distance, moving average factor, and number of direction changes. Other statistical features may be used as part of the crime patterning process.

The assignment of the first region to a cluster is based on the first time based crime pattern (404). For example, recommendation system 160 may assign region 111 and region 112 to a cluster based on the similarity of the crime pattern features associated with region 111 and the crime pattern features associated with region 112.

The first time series is augmented with a second time series to create an augmented time series where the second time series is associated with a second geographical region in the cluster (406). For example, a time series dataset for region 112 (which is in the same cluster as region 111) that is based on crime information from database 142 may be used to augment the time series dataset for region 111.

A second time based crime pattern that is based on the augmented time series is generated (408). For example, the augmented time series may be analyzed for crime pattern features such as trend, seasonality, serial correlation, non-linearity, skewness, kurtosis, self-similarity, chaos, frequency of periodicity, average Maharaj Distance, moving average factor, and number of direction changes. Other statistical features may be used as part of the crime patterning process.

A recommended operational allocation is based on the second time based crime pattern (410). For example, recommendation system 160 may correlate the operational information from the regions in the cluster with the crime pattern that was based on the augmented time series. Thus, recommendation system 160 may, based on the correlations (or lack thereof) between the operational decisions and the crime pattern from the augmented time series, make an operational recommendation for a geographical region 111-114.

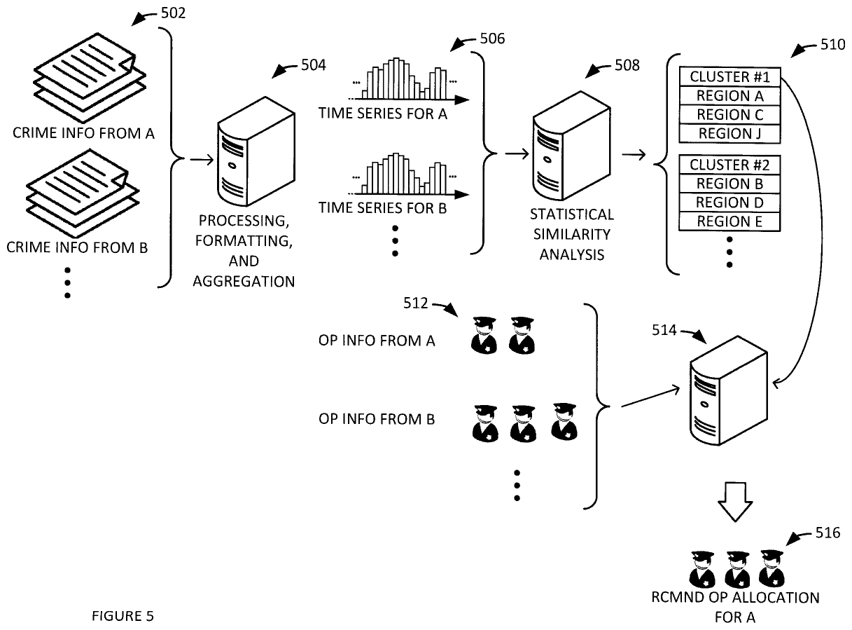

FIG. 5 is a diagram illustrating operational recommendations based on multi-jurisdictional inputs. In FIG. 5, sets of crime information 502 from multiple geographical regions (e.g., jurisdictions, analysis cell, etc.) are provided to processing node 504 for (at least) formatting and aggregation. Processing node 504 generates time series datasets 506 for the geographical regions. The time series datasets 506 associated with the geographical regions (e.g., geographical region A, geographical region B, etc.) are provided to processing node 508 for statistical similarity analysis. Processing node 508 also clusters (e.g., into cluster #1, cluster #2, etc.) these geographical regions based on the statistical similarities among the time series datasets 506.

Cluster information 510 is provided to processing node 514. Processing node 510 also receives operational information 512 from the geographical regions. Processing node 514 uses the clustering information 510 and the operational information 512 to generate a recommended operational allocation (e.g., shift staffing level) for at least one of the geographical regions (e.g., geographical region A.)

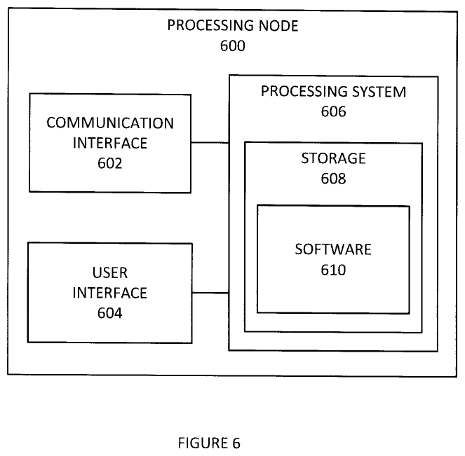

FIG. 6 illustrates an exemplary processing node 600 comprising communication interface 602, user interface 604, and processing system 606 in communication with communication interface 602 and user interface 604. Processing node 600 is capable of paging a wireless device. Processing system 606 includes storage 608, which can comprise a disk drive, flash drive, memory circuitry, or other memory device. Storage 608 can store software 610 which is used in the operation of the processing node 600. Storage 608 may include a disk drive, flash drive, data storage circuitry, or some other memory apparatus. Software 610 may include computer programs, firmware, or some other form of machine-readable instructions, including an operating system, utilities, drivers, network interfaces, applications, or some other type of software. Processing system 606 may include a microprocessor and other circuitry to retrieve and execute software 610 from storage 608. Processing node 600 may further include other components such as a power management unit, a control interface unit, etc., which are omitted for clarity. Communication interface 602 permits processing node 600 to communicate with other network elements. User interface 604 permits the configuration and control of the operation of processing node 600.

Examples of processing node 600 includes recommendation system 160, processing nodes 504, 508, and 514. Processing node 600 can also be an adjunct or component of a network element, such as an element of network 150.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a crime forecasting system, comprising:
receiving, from a plurality of source databases, crime information that corresponds to a plurality of crimes occurrences, the information including respective locations for the plurality of crime occurrences, respective times for the plurality of crime occurrences, and respective types of crime for the plurality of crime occurrences;
processing the crime information into a plurality of time series datasets associated with substantially non-overlapping geographical regions, the time series datasets relating time information to crime occurrences in respective substantially non-overlapping geographical regions;
based on the plurality of time series datasets, generating clustering information that groups a target geographical region with a first set of the substantially non-overlapping geographical regions, the clustering information being based on statistical similarities among respective time series datasets associated with the target geographical regions and each of the first set of substantially non-overlapping geographical regions;
receiving operational information associated with at least one of the first set of substantially non-overlapping geographical regions; and,
based on the operational information associated with at least one of the first set of substantially non-overlapping geographical regions, and the clustering information, selecting a recommended operational allocation to be used in the target geographical region.

2. The method of claim 1, wherein the operational allocation includes at least one of a beat schedule and a shift schedule.

3. The method of claim 2, further comprising:
receiving operational information associated with the target geographical region, wherein the recommended operational allocation is further based on the operational information associated with the target geographical region.

4. The method of claim 2, further comprising:
calculating a first time based crime pattern based on a first time series dataset of the plurality of time series datasets, wherein the clustering information is based at least in part on the first time based crime pattern.

5. The method of claim 4, further comprising:
augmenting the first time series dataset with a second time series dataset to create an augmented time series dataset, the second time series dataset to be based on at least one time series dataset relating time information to crime occurrences in at least one of the first set of substantially non-overlapping geographical regions that are not the target geographical region.

6. The method of claim 5, further comprising:
calculating a second time based crime pattern based on the augmented time series dataset, wherein the recommended operational allocation is further based on the second time based crime pattern.

7. The method of claim 4, further comprising:
correlating the first time based crime pattern with the operational information associated with the target geographical region.

8. A method of operating a crime forecasting system, comprising:
receiving, from a plurality of source databases, crime information that corresponds to a plurality of crimes occurrences, the information including respective locations for the plurality of crime occurrences, respective times for the plurality of crime occurrences, and respective types of crime for the plurality of crime occurrences;
processing the crime information into a plurality of time series datasets associated with a set of geographical regions, the time series datasets relating time information to crime occurrences in respective geographical regions;
calculating, based on the plurality of times series datasets, a set of statistical feature sets associated with crime patterns in respective members of the set of geographical regions;
based on the statistical feature sets, associating a subset of geographical regions with a cluster of geographical regions;
receiving a set of operational decisions associated with each of the respective members of the cluster of geographical regions;
correlating the set of operational decisions with the crime patterns in each of the respective members of the cluster of geographical regions; and,
based on the correlations between the set of operational decisions and the crime patterns, generating an operational recommendation for at least one of the geographical regions.

9. The method of claim 8, the operational recommendation includes at least one of a change to a beat schedule and a change to a shift schedule.

10. The method of claim 8, wherein the statistical feature sets correspond to patterns, in time series datasets, that relate crime occurrences to time information.

11. The method of claim 10, wherein the associating of the subset of geographical regions with a cluster of geographical regions is based on measurements of similarity of crime patterns between clusters as compared to similarity within clusters.

12. The method of claim 10, wherein the associating of the subset of geographical regions with a cluster of geographical regions is further based on attributes comprising demographic attributes and functionality attributes.

13. The method of claim 12, further comprising:
determining a set of performance indicators based on the statistical feature sets associated with crime patterns.

14. The method of claim 13, wherein the operational recommendation for at least one of the geographical regions is based on the set of performance indicators.

15. A law enforcement forecasting system, comprising:
a network interface to receive, from a plurality of source databases, crime information that corresponds to a plurality of crimes occurrences, the information including respective locations for the plurality of crime occurrences, respective times for the plurality of crime occurrences, and respective types of crime for the plurality of crime occurrences;
a processor; and,
a non-transitory computer readable medium having instructions stored thereon that, when executed by the processor, at least instruct the processor to:
group a target geographical region with a first set of substantially non-overlapping geographical regions based on statistical similarities among respective time series datasets associated with the target geographical regions and each of the first set of substantially non-overlapping geographical regions;
process the crime information into a plurality of time series datasets associated with substantially non-overlapping geographical regions, the time series datasets relating time information to crime occurrences in respective substantially non-overlapping geographical regions
receive operational information associated with at least one of the first set of substantially non-overlapping geographical regions; and,
based on the operational information associated with at least one of the first set of substantially non-overlapping geographical regions, and the clustering information, select a recommended operational allocation to be used in the target geographical region.

16. The system of claim 15, wherein the operational allocation includes at least one of a beat schedule change and a shift schedule change.

17. The system of claim 16, wherein the processor is further instructed to:
calculate a first time based crime pattern based on a first time series dataset, wherein grouping the first set of substantially non-overlapping geographical regions is based at least in part on the first time based crime pattern.

18. The system of claim 17, wherein the processor is further instructed to:
augment the first time series dataset with a second time series dataset to create an augmented time series dataset, the second time series dataset to be based on at least one time series dataset relating time information to crime occurrences in at least one of the first set of non-overlapping geographical regions that are not the target geographical region.

19. The system of claim 18, wherein the processor is further instructed to:
calculate a second time based crime pattern based on the augmented time series dataset, wherein the recommended operational allocation is further based on the second time based crime pattern.

20. The system of claim 17, wherein the processor is further instructed to:
correlate the first time based crime pattern with the operational information associated with the target geographical region.
